(19) United States
(12) Patent Application Publication
(10) Pub. No.: US 2026/0116545 A1
(43) Pub. Date: Apr. 30, 2026

(54) PIVOTAL FOLDING SEAT FOR CABIN CREW AND AIRCRAFT HAVING THE PIVOTAL FOLDING SEAT

(71) Applicants: Diehl Aviation Laupheim GmbH, Laupheim (DE); Diehl Aviation Hamburg GmbH, Hamburg (DE)

(72) Inventors: Martin Schuermann, Hamburg (DE); Sebastian Tivig, Hamburg (DE); Nils Bornhöft, Norderstedt (DE)

(21) Appl. No.: 19/397,243

(22) Filed: Nov. 21, 2025

Related U.S. Application Data
(63) Continuation of application No. PCT/EP2024/064182, filed on May 23, 2024.

(30) Foreign Application Priority Data
May 30, 2023 (DE) 10 2023 114 095.7

(51) Int. Cl. B64D 11/06

(52) U.S. Cl. CPC B64D 11/0691; B64D 11/0698; B64D 11/0601

(57) ABSTRACT

A seat assembly for a passenger cabin of an aircraft having a holding wall which is permanently secured to the base structure of the aircraft and a seat for the cabin crew. The seat is secured to the holding wall solely by a rotational axis and being rotatable by 30° to 300° between two end positions and between seat positions in which a sitting position of a seat surface of the seat is facilitated. The aircraft has the base structure, the passenger cabin, and the seat assembly with the permanently secured holding wall in the intended installation state. The seat can be rotated about each of the rotational axes between the two end positions and between the seat positions, and the sitting position of the seat surface is facilitated in each of the seat positions.

### CROSS-REFERENCE TO RELATED APPLICATION

This application is a continuation, under 35 U.S.C. § 120, of copending International Patent Application PCT/EP2024/064182, filed May 23, 2024, which designated the United States; this application also claims the priority, under 35 U.S.C. § 119, of German Patent Application DE 10 2023 114 095.7, filed May 30, 2023; the prior applications are herewith incorporated by reference in their entirety.

### FIELD AND BACKGROUND OF THE INVENTION

The invention relates to a folding seat for cabin crew, for example flight attendants.

Published, European patent application EP 0 268 749 A1, corresponding to U.S. Pat. No. 4,799,632, discloses a vehicle seat constructed as a dual seat, in particular a seat for flight attendants on airplanes. The seat consists of a frame which is provided with cushions on two sides and is formed from dual pillars and cross members and on both sides of which foldable seats are arranged.

### SUMMARY OF THE INVENTION

The present invention addresses the problem of proposing improvements in relation to a folding seat for cabin crew.

The problem addressed by the invention is solved by a seat arrangement according to the independent seat arrangement claim. Preferred or advantageous embodiments of the invention and of other invention categories can be found in the further claims, the following description and the appended figures.

With the foregoing and other objects in view there is provided, in accordance with the invention, a seat configuration for a passenger cabin of an airplane. The seat configuration contains: a retaining wall for being permanently fastened to a main structure of the airplane when the retaining wall is in an intended installed state in the passenger cabin; vertical pivot pins; and a seat for cabin crew members and has a seating surface being foldable between a sitting position and a rest position. The seat is fastened to the retaining wall only by means of at least one of the vertical pivot pins. The seat is rotatable about each of the vertical pivot pins between a first and a second end position. The first and second end positions are offset with respect to one another through an angular range of at least 30° and at most 300°. The seat is rotatable about the vertical pivot pins between at least two seat positions. The sitting position of the seating surface is allowed in each of the seat positions. The retaining wall is a partition wall for the passenger cabin, and the partition wall has a first wall portion and a second wall portion. The first and second wall portions are separated by a gap and the seat is rotatable into one of the first and second end positions in which the seat is disposed in the gap.

The seat arrangement is a seat arrangement for a passenger cabin of an airplane. “Airplanes” should be understood as being all kinds of aircraft which usually fly with cabin crew and thus, in normal operation, require seating, in particular a folding seat, for cabin crew, in particular passenger planes.

The seat arrangement contains a retaining wall that is able to be permanently fastened at least indirectly or directly to a main structure of the airplane. The fastening relates to an intended installed state of the seat arrangement in the (intended) passenger cabin. In other words, in the installed state, the retaining wall is permanently fastened to the main structure of the airplane.

“Intended” means that the seat arrangement is structurally compatible with a particular, or a particular type of, airplane or passenger cabin and has been designed for use therein; for example, is configured for the geometric/material and system requirements etc. determined thereby. In other words, in particular an airplane/passenger cabin in question is assumed to be known in terms of its geometry, size, material properties etc.

The seat arrangement contains a seat for cabin crew. The retaining wall is designed such that it can act as a supporting part for the seat, i.e. meets the mechanical requirements therefor. The seat contains a seating surface. The seating surface is foldable between a sitting position and a rest position. In the rest position, the seating surface is stowed in a space-saving manner on the seat. In the sitting position, the seat is suitable for a member of the cabin crew (in particular a CA, cabin attendant) to be able to sit on the seat or the seating surface.

The seat is fastened to the retaining wall by means of at least, in particular exactly, one pivot pin (this means, at the same time, a supporting fixture of the pivot joint type). In this case, the seat is permanently fastened only via this pivot pin, i.e. there is no further permanently mechanically supporting connection between the seat and retaining wall. At most, there are support holders/support elements (see below); these do not cooperate permanently, however, but at most temporarily. The pivot pin extends vertically in the intended installed state, wherein “vertically” relates to a state of the airplane when the latter is at rest on level ground, for example in a parked position at an airport. In other words, the pivot pin extends perpendicularly to a floor of the passenger cabin or of the airplane.

For each of the pivot pins, the following applies: The seat is rotatable about the respective pivot pin in each case between a first and a second end position. In other words, the seat can be turned about the pivot pin between the two end positions. The end positions define an angular range of the possible rotations. All of this applies especially in the intended installed state, i.e. in the airplane (see below). In the installed state, the seat is thus rotatable about the pivot pin about the vertical pivot pin, relative to the retaining wall and to the rest of the passenger cabin or the rest of the airplane, through the angular range between the end positions (inclusive). The two end positions are offset with respect to one another through the angular range. Possible angular ranges lie between at least 30° and at most 300°. In other words, the seat is thus able to be turned about the pivot pin through an angle of between 30° and 300° between the two end positions. Beyond the end positions, the seat is unable to be rotated further. The angular range is in particular 90°, in particular 180° or in particular 270°. For different pivot pins, different angular ranges may exist. In particular, two pivot pins are provided, where one has an angular range of 270° with a stowed position and the other has an angular range of 90°. When there are two pivot pins, one always has to be released in order that the seat is able to be rotated about the other pivot pin.

Each of the pivot pins may be in the form of a single continuous hinge or in the form of at least two aligned part-hinges. The hinges may be exposed or may have been introduced/incorporated entirely or partially into the seat and/or the retaining wall.

The seat is furthermore rotatable about the pivot pins between at least, in particular exactly, two seat positions. The seat positions thus lie within the angular range, at most in the corresponding end positions. In particular, the seat positions are offset with respect to one another through 90° or 180°. The sitting position of the seating surface is allowed in each of the seat positions. This also applies especially in the installed state, i.e. in the airplane with the installed seat arrangement. Thus, in all seat positions, the seat can actually act (with the seating surface in the sitting position) as a seat for members of the cabin crew. In other words, in the sitting positions, it is possible in particular to fold the seating surface between the rest position and the sitting position. In particular, two seat positions are possible with regard to at least one of the pivot pins. The rotation about just one of the pivot pins thus already allows the adoption of two different seat positions.

In particular, the seat contains a seat structure and the partition wall contains a wall structure of a supporting structure, as are known from the post-published German patent application DE 10 2022 108 421.3 of Diehl Aviation Hamburg GmbH. In other words, the seat and retaining wall form an integrated arrangement made up of the partition wall (or “partition”) and seat arrangement (CAS) of the “integrated CAS partition” or “i-CAS partition” type explained therein.

The fact that the seat is usable in at least two rotational positions, specifically the seat positions actually for sitting, results in a particularly flexible possible use of the seat. In particular, in each flight phase, the seat can always actually be used by cabin crew for sitting.

In one preferred embodiment, at least one of the seat positions is one of the end positions. Thus, the seat can actually be used by cabin crew for sitting in particular in one of the end positions.

In a preferred variant of this embodiment, two of the seat positions are the two end positions. Thus, the seat can actually be used by cabin crew for sitting in both end positions.

In one preferred embodiment, the seat is rotatable about the pivot pin into at least one stowed position. In the stowed position, the sitting position of the seating surface is not allowed. Thus, in the stowed position, it is not possible for cabin crew to actually use the seat for sitting; instead, in particular the rest position of the seating surface is possible there, in particular only the rest position, such that the seat is stowed in a particularly space-saving manner. Besides two possible sitting positions, the seat can therefore additionally be stowed in a space-saving manner as desired or required.

One preferred variant of this embodiment is not combinable with the abovementioned embodiment in which two seat positions take up the end positions: In this embodiment, one of the stowed positions is also one of the end positions. This end position then ceases to be a seat position. This means, however, that as a result of fully pivoting/rotating the seat into the end position, the stowed position is also reached at the same time.

According to one preferred embodiment, there is an alternative to the stowed position; in this embodiment, a stowed position is thus not provided. In this embodiment, the sitting position of the seating surface is allowed in each rotational position of the seat between the end positions. This also applies again in particular in the installed state, i.e. in the airplane. The two end positions are in this case included. In this embodiment there is thus no stowed position. Thus, all the rotational positions are available for sitting positions. Thus, in all the rotational positions, it is actually possible for cabin crew to use the seat for sitting. As a rule, however, again only particular rotational positions are used for sitting, these then corresponding to dedicated sitting positions. This is, in particular, because of appropriate support by support elements/support holders and/or locking by lock elements in the corresponding sitting positions (see below). This embodiment also applies especially also in the installed state, i.e. when installed in the airplane.

In one preferred embodiment, the seat is located parallel to the retaining wall and in front of the retaining wall in one of the seat positions. “Parallel” means that the seat, or the backrest/rear part thereof, is oriented parallel to a plane of extension of the retaining wall. “In front of the retaining wall” means that a sitting direction, or a straight-ahead viewing direction of a person sitting facing forward on the seat is directed away from the retaining wall perpendicularly to the plane of extension thereof. The seat, or the seating surface, or the corresponding viewing direction is thus directed away from the retaining wall. In other words, the retaining wall is located “at the back” of a person currently sitting on the seat. The seat is thus arranged on the retaining wall in a space-saving manner and in the manner usual in practice in the seat position in question.

In one preferred embodiment, the retaining wall is a partition wall, or partition, for the passenger cabin, or the retaining wall is a wall portion of a monument for the passenger cabin, for example a lavatory, a galley or a cabinet. As a result of a corresponding pivoting seat being attached to the retaining wall, the partition or the monument is assigned a corresponding retaining function for the seat. Furthermore, the retaining wall then has a dual function, specifically that of a partition wall or a wall of a monument.

In a further preferred embodiment, in which the retaining wall is a partition wall, the partition wall has a first wall portion and a second wall portion. The two wall portions are separated by a gap. The gap is thus located between the two wall portions. The seat is in this case rotatable into an end position in which it is arranged in the gap. This applies at least with the seat surface folded out, i.e. in the sitting position. The two wall portions are in this case arranged in an aligned manner along an axis. The two wall portions can also be formed by wall portions of different monuments. With the partition wall fitted as intended in the airplane, in which case the axis is arranged transversely to the airplane longitudinal direction or the flight direction, the gap serves to form a passage in the airplane. The pivot pin is preferably fastened to the first wall portion of the partition wall and thus of the retaining wall.

A first end position coincides in particular with a first seat position. In the first seat position, the seat is located parallel to the retaining wall and thus to the partition wall and the first wall portion thereof. Furthermore, the seat is located in front of the retaining wall or partition wall and the first wall portion. This means that a person who sits down on the seat with the seating surface in the sitting position in the first seat position has the retaining wall or the partition wall and thus the first wall portion at their back. Even this first seat position can be a TTL observation position. This means: During the flight phases of taxiing, takeoff and landing (TTL), a flight attendant of the cabin crew who sits on the seat has an unobstructed view, in the x direction, i.e. the flight direction, of passengers located in the passenger cabin.

The seat can be rotated about the pivot pin from this first end position into a second end position, wherein the two angular positions of the two end positions are offset by an angle of 180°. In this case, the pivot pin is arranged on the first wall portion and fastened thereto such that, as a result of the seat being rotated about the pivot pin, the seat is rotatable into a second end position, in which the seat is arranged in the gap. In this second seat position, which coincides with the second end position and represents a further TTL position, a person who has sat down on the seat can look in the opposite direction compared with the first seat position. In the intended state, the person who is thus sitting in the gap can look along an aisle located in the airplane. As a result of such a configuration, a CAS is usable flexibly with the total weight being reduced at the same time.

In a preferred embodiment, the seat arrangement comprises at least one lock element. The lock element is configured to lock the seat in at least one of the end positions and/or seat positions and/or—only if, as above, the embodiment of a stowed position is realized—stowed positions. This does not preclude the lock element from also additionally being able to lock the seat in other rotational positions or in some other way. Thus, in particular accidental or unintentional pivoting of the seat is prevented with the lock element locked. In particular in the above-described embodiment with the partition wall having a first wall portion and a second wall portion, the seat arrangement can comprise two lock elements. With a first lock element, the seat is able to be locked in the first end position. The first lock element is in particular arranged on the first wall portion or integrated into the latter. With the second lock element, the seat is able to be locked in the second end position. The second lock element is in particular arranged on the second wall portion or integrated into the latter. The second lock element can also additionally have an emergency unlocking mechanism. This serves for it to be possible to quickly unlock the seat in an emergency and thus to be able to rotate it out of the second end position such that the gap between the two wall portions can be opened up. This opens up an escape route. In addition, in this second end position, a self-unlocking mechanism can be provided, with the aid of which it is possible for the second lock element also to be unlocked when the seating surface is folded up. Conversely, there can also be a self-locking mechanism, such that, when the seating surface is folded down, automatic locking of the second lock element and thus of the seat in the second end position or seat position is achieved. In other words: The seating surface serves as an actuating element for the lock element. With the aid of the seating surface, the seat can thus be locked or unlocked or is lockable or unlockable.

In a preferred embodiment, the seat arrangement comprises at least one support holder, in particular two support holders. The support holder is fastened to the retaining wall, in particular the partition wall, or formed thereby. In the above-described embodiment of the partition wall having a first wall portion and a second wall portion, a first support holder can be fastened to or formed by the first wall portion and a second support holder can be fastened to or formed by the second wall portion, or they can also be integrated into the respective wall portions.

Furthermore, the seat may have a support element. With the support element, the seat is supported or able to be supported on at least one of the support holders in particular in at least one of the end positions and/or seat positions and/or—if they exist—the stowed positions—in particular with respect to an x load and/or a z load. The x direction is the straight-ahead flight direction of the airplane, and the z direction is a vertical direction, when the airplane is at rest on level ground. The support holder can support the load of the seat with respect to the retaining wall.

The problem addressed by the invention is also solved by an airplane according to the independent airplane claim. The airplane is one as mentioned above and contains the abovementioned main structure and the abovementioned passenger cabin. The airplane furthermore contains the seat arrangement according to the invention. The seat arrangement is located in the abovementioned intended installed state in the passenger cabin or in the airplane. The retaining wall is therefore permanently fastened to the main structure of the airplane. The seat is rotatable about each of the pivot pins between the two end positions and between the seat positions and the sitting position of the seating surface is allowed in each of the seat positions.

The airplane and at least some of the possible embodiments thereof and the respective advantages have already been explained, mutatis mutandis, in conjunction with the seat arrangement according to the invention.

In a preferred embodiment, the seat is fastened to the main structure only via the retaining wall. The fastening is again indirect or direct. There is thus no other permanent and rotatable fastening of the seat to the main structure besides the fastening via the retaining wall. In other words, the seat is fastened (indirectly or directly) only to the retaining wall and only the latter is fastened (indirectly or directly) to the main structure. Temporary additional fastenings, for example supporting or locking (see below) are, in particular, conceivable, however. Thus, an additional permanent fastening of the seat to the main structure, for example to a floor of the passenger cabin, is unnecessary.

In one preferred embodiment, one of the seat positions is a TTL (taxi takeoff landing) observation position for the passenger cabin. In particular, this observation position is a second seat position with respect to the abovementioned other seat position with the retaining wall at the back. In these critical TTL flight phases, aviation regulations require that each passenger seat in a passenger plane is under permanent visual observation by cabin crew. This TTL requirement can be met by the corresponding seat position. Equally, the seat can be used in another seat position during other flight phases. Preferably, two seat positions, which each coincide with one of the end positions, are TTL observation positions.

In one preferred embodiment, the airplane contains at least one lock element. In particular, the lock element is part of the seat arrangement. The lock element is designed to lock the seat in at least one of the end positions and/or seat positions and/or—only if, as above, the embodiment of a stowed position is realized—stowed positions. This does not preclude the lock element from also additionally being able to lock the seat in other rotational positions or in some other way. Thus, in particular accidental or unintentional pivoting of the seat is prevented with the lock element locked.

In one preferred embodiment, the airplane contains at least one support holder. The support holder is likewise fastened at least indirectly to the main structure. The support holder can also be part of the seat arrangement. The fastening then occurs in the intended installed state. In particular, the support holder is fastened permanently to the main structure. The seat has a support element. With the support element, the seat is supported or able to be supported on at least one of the support holders in particular in at least one of the seat positions—in particular with respect to an x load and/or a z load. The x direction is the straight-ahead flight direction of the airplane, and the z direction is a vertical direction, when the airplane is at rest on level ground. The support holder can support the load of the seat with respect to the main structure of the airplane. The load does not need to be supported only via the pivot pin and the retaining wall. The pivot pin can thus be embodied in a mechanically less stable and therefore less complicated and more inexpensive manner. In particular, a plurality of support holders can be provided, for example one each for one or more of the seat positions and/or end positions and/or stowed positions, if the latter exist. In particular, the load holder is a part of an installation element of the airplane, for example of a monument, a row of seats, a storage compartment, etc. In other words, the installation part contains or forms the support holder.

Alternatively or additionally, the seat can also be supported via the support elements/support holders in the end positions and/or stowed positions.

In a preferred variant of this embodiment, the retaining wall contains at least one of the support holders or the retaining wall forms at least one of the support holders. In particular, the seat can thus be supported in the particular seat position that arises when the seat, as explained above, is arranged in front of the retaining wall.

The invention is based on the following findings, observations and considerations and also has the following preferred embodiments. These embodiments are also sometimes referred to, for simplification purposes, as “the invention”. The embodiments may in this case also contain or correspond to parts or combinations of the abovementioned embodiments and/or possibly also include embodiments that have not previously been mentioned.

According to the invention, in particular a rotatable seat for cabin crew is produced, which is integrated in a partition wall (partition) or other walls and monuments in the airplane.

The invention is based on the following idea: An i-CAS partition, as is known from the abovementioned patent application, combines two conventional functions into one function (partition+CA seat, CA: cabin attendant/cabin crew). The present invention extends the concept with a rotatable (“swivel”)-CAS (cabin attendant seat) for the cabin crew. Furthermore, the principle is applicable to any form of monuments, partition walls or other installations.

The invention is based on the following observation: current swivel-CASs are fastened to the airplane floor and usually rotatable only through 90°. Furthermore, they are usable only in specific flight phases (TTL: taxi, takeoff, landing) and do not form a resting seat during cruising flight.

The seats are installed independently of partition walls or monuments. The loads are thus not shared with other installations, but introduced directly into the floor. During cruising flight, they cannot be used since they impede passages in the cabin, for example access to the lavatory.

An essential driving force for these seats is the “direct view” criterion, according to which the cabin crew has to be able to see all the passengers from the seat during the critical flight phases. A camera system forms an alternative solution for “direct view”.

The basic concept of the invention is the development of possible way of integrating the swivel-CAS into partition walls and monuments and thus to create a possibility for “direct view”) (direct visual observation of the passengers during TTL). In this case, use should be made of the novel design of the i-CAS partition (monolithic aluminum metal design). The seat should be usable during taxiing, takeoff and landing, and during the normal flight phase. The development of this design involves considerable cost potential, potential to reduce the weight compared with the established solution, and affords usability in all flight phases, such that a separate seat for the normal flight phase is not required (further weight and cost reduction). Furthermore, this compact design allows more space in the airplane longitudinal direction.

The invention is based on the observation that the partition wall or usually monument and seat exist as separate components. For actual use and achievement of the “direct view”, the seat, which is usually pivotable through 90°, is fastened to the floor independently of other components. The partition walls and monuments are in this case produced in a composite design from metal-reinforced honeycomb panels with pre-impregnated fiber-matrix semifinished products (“prepregs”). Alternatively, to meet the “direct view” criterion, a camera system is used.

According to the invention, the structural components of the seat, including the entire mechanism for rotating the seat through up to 180°, are transferred, as a so-called integral design, into the structure of the partition wall. The CA seat as a separately existing product is thus eliminated. An integral component is produced, which has the key features of both previously separate products. In the rotated state, the seat is supported, on the opposite side, on a partition wall, a monument or the like (support element/support holder). In this way, forces in the x and z direction are absorbed. This allows a further weight reduction.

In combination, the novel design allows a reduction in the overall weight and the structural depth while maintaining the maximum deformation under load. This is the case for the partition wall or the monument regardless of whether one or more further CA seats are integrated. Furthermore, a reduction in the production costs is possible.

The separation of the products CAS and monument/partition wall etc. is thus eliminated. An integrated product exists, which unites the function of CAS and monument/partition wall etc. This is the case in the standard i-CAS solution. What is novel in relation to the standard i-CAS solution in the present case is that one of the seats is embodied in a rotatable manner. The rotation can take place here in any angular range up to 270 degrees. The direction of view in the rotated position can be both in the flight direction and counter to the flight direction, regardless of the application. The CAS can be used as a full-fledged CAS in the non-rotated position regardless of the application. Thus, flexible use is possible. The solutions reduce the weight compared with current solutions and provide at least 1 inch more space in the cabin longitudinal direction. Furthermore, the seat, depending on the application, can be used not only in critical flight phases (direct view) but also as a resting seat.

The “seat in product” principle has been described sufficiently well by the i-CAS patent application and will not be described in more detail here. The expression “retaining product” in the following text always describes the product in which the rotatable CAS is integrated, i.e., for example, a partition wall or a monument or the like.

For the rotation mechanism, several solutions are conceivable.

Integration of the pivot pin into the retaining product. The load is introduced over the entire height or continuously over a part of the height. The mechanism is only partially visible. It can optionally be more significantly concealed.

Mechanism screwed onto the retaining product. The load is introduced over the entire height or continuously over a part of the height. The mechanism is completely visible and has been screwed onto the retaining product.

Point load introduction by way of an integrated pivot pin. To this end, at least two hinges are necessary. The load is introduced into the retaining product via dedicated points. The mechanism is only partially visible. It can optionally be more significantly concealed.

Point load introduction by way of a screwed-on mechanism. To this end, at least two hinges are necessary. The load is introduced into the retaining product via dedicated points.

The rotated seat requires a bearing support. This makes it possible distribute the loads in the rotated state and thus allows a weight reduction of the system as a whole. Solutions for load support by the bearing support have the following characteristics.

The bearing support primarily provides non-locked support in the x direction.

The bearing support provides non-locked support in the z direction.

Alternatively, locking of the fold-up function can be offered. This locking is characterized in that it does not transmit any loads and prevents only folding up/away about the z axis and the seat does not rotate “accidentally” out of the TTL position.

The bearing support optionally provides damping of rattling and other noises and vibrations.

In the event of an emergency landing or some other incident, the hinge and bearing support remain fully functional.

The invention can be used in all airplanes in which a rotatable CAS is currently used. And also in layouts in which densification products are used. Wherever a CAS or camera system is required for direct view. Usually, the aft section in single aisle airplanes. Applications in the front region of the cabin are conceivable.

Other features which are considered as characteristic for the invention are set forth in the appended claims.

Although the invention is illustrated and described herein as embodied in a pivotal folding seat for cabin crew, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, plan view showing a detail of an airplane with a passenger cabin and seat arranged therein;

FIG. 2 is a detailed perspective view showing the seat arrangement from FIG. 1;

FIG. 3 is a plan view of the situation from FIG. 1 in an enlarged detail of the airplane;

FIG. 4 is a top view showing an alternative seat arrangement with additional CAS seats and cabin crew;

FIG. 5 is a side view showing the seat arrangement from FIG. 1 with an external hinge;

FIG. 6 is a side view showing the seat arrangement with internal part-hinges; and

FIG. 7 is an illustration showing an alternative seat arrangement as per FIG. 3.

### DETAILED DESCRIPTION OF THE INVENTION

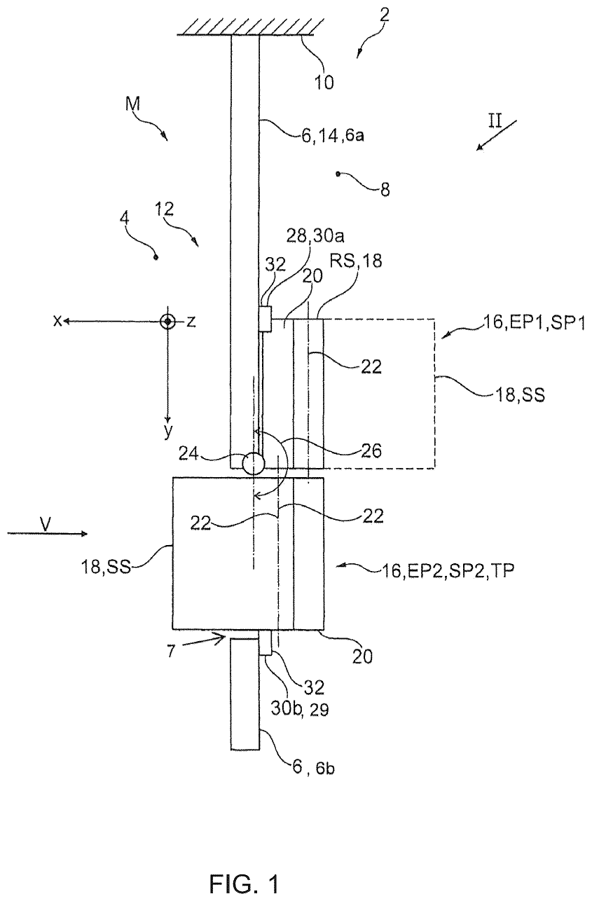

Referring now to the figures of the drawings in detail and first, particularly to FIG. 1 thereof, there is shown a highly abstract plan view of a detail of an airplane 2, or a passenger cabin 4 thereof (view counter to the z direction, which passes out of the plane of the paper). The passenger cabin 4 extends in the x direction (straight-ahead direction of flight) on the other side of a partition wall 6, or partition. In the rear part of the airplane 2, a service area 8 adjoins the passenger cabin 4 counter to the x direction.

The airplane 2 contains a main structure 10 which is indicated only symbolically here (fuselage structure, supporting basic structure). A seat arrangement 12 is installed in an intended installed state M in the airplane 2 or the passenger cabin 4. The seat arrangement 12 contains a retaining wall 14, which is formed in the present case by the upper portion, in the figure, of the partition wall 6, which in turn forms a first wall portion 6a of the partition wall. A second wall portion 6b is separated from the first wall portion 6a by a gap 7. This gap 7 serves to allow people in the airplane 2 to pass through the partition wall 6 and thus to be able to move along an aisle that extends through the gap 7. The retaining wall 14 is permanently fastened to the main structure 10 of the airplane 2. The seat arrangement 12 is thus a seat arrangement for the passenger cabin 4 of the airplane 2. The retaining wall 14 is thus permanently fastened to the main structure 10 in the intended installed state M in the passenger cabin 4. The retaining wall 14 is in this case thus a partition or partition wall 6 of the passenger cabin 4.

The seat arrangement 12 contains a seat 16, in this case a folding seat, for cabin crew (not illustrated). The seat 16 contains a seating surface 18 and a backrest 20. The seating surface 18 is foldable about a folding axis 22 between a sitting position SS and a rest position RS. The seat 16 is fastened to the retaining wall 14 only by means of a pivot pin 24. The pivot pin 24 extends vertically, i.e. in the z direction.

The seat 16 is rotatable about the pivot pin 24 between a first end position EP1 and a second end position EP2. The entire possible rotation range extends through an angular range 26, indicated by a double arrow, which in this case is 180°. The end positions EP1,2 are thus offset with respect to one another through the angular range 26 of 180°. The end positions EP1,2 and angular range 26 are indicated by dashed lines.

Equally, the seat 16 is rotatable about the pivot pin 24 between two seat positions SP1,2. The sitting position SS of the seating surface 18 is allowed in each of the seat positions SP1,2. In the present case, the seat position SP1 coincides with the end position EP1 and the seat position SP2 coincides with the end position EP2. In the present case, the sitting position SS of the seating surface 18 is even allowed in each rotational position of the seat 16 between the end positions EP1,2. A stowed position UP (see below), in which the sitting position SS of the seat 16 is not allowed, does not exist in this exemplary embodiment.

The seat 16, which is actually present only once, is illustrated twice to explain the seat positions SP1,2.

In the seat position SP1, or the end position EP1, the seat is located parallel to the retaining wall 14 and in front of the retaining wall 14. This means that a person who sits down on the seat 16 with the seating surface 18 in the sitting position SS and their back facing the backrest 20 has the retaining wall 14 at their back.

In the airplane, the seat 16 is permanently fastened to the main structure 10 only indirectly via the retaining wall 14. Another type of permanent fastening between the seat 16 and main structure 10 does not exist. The seat position SP2 is in this case a TTL observation position TP. This means: During the flight phases of taxiing, takeoff and landing (TTL), a flight attendant of the cabin crew who sits on the seat 16 has an unobstructed view, in the x direction, i.e. the flight direction, of passengers located in the passenger cabin 4. In the seat position SP2, or the end position EP2, the seat 16 is arranged in the gap 7. Thus, the seat 16 is located between the first wall portion 6a and second wall portion 6b. In this seat position SP2, which coincides with the second end position EP2 and represents a further TTL position, a person who has sat down on the seat 16 can look in the opposite direction compared with the seat position SP1.

The airplane 2, or the seat arrangement 12, contains a lock element 28, which is indicated only symbolically here. This is designed or serves to lock the seat 16 in the seat position SP1 or end position EP1, such that it cannot be removed from the particular position again without the lock element 28 being unlocked. The lock element 28 is arranged on or integrated in the first wall portion 6a. Furthermore, the airplane 2, or the seat arrangement 12, contains a second lock element 29. With the second lock element 29, the seat 16 is able to be locked in the end position EP2. The second lock element 29 is arranged on or integrated in the second wall portion 6b.

The airplane 2 also contains two support holders 30a,b, which are indicated only symbolically here and are each arranged on or formed by the partition wall 6. In this case, a first support holder 30a is arranged on, integrated in or formed by the first wall portion 6a and a second support holder 30b is arranged on, integrated in or formed by the second wall portion 6b. By means of the partition wall 6, the support holders 30a,b are also permanently fastened to the main structure 10 and can thus be used to support load. The seat 16 contains a support element 32, with which it is supported on the respective support holder 30a or 30b in both seat positions SP1,2 with respect to an x load and a z load. Corresponding x and z loads from the seat 16 are thus diverted to the main structure 10 via the support element 32 and support holder 30a or support holder 30b and the partition wall 6. In other words, the retaining wall 14 in the form of the partition wall 6 forms or contains the two support holders 30a,b.

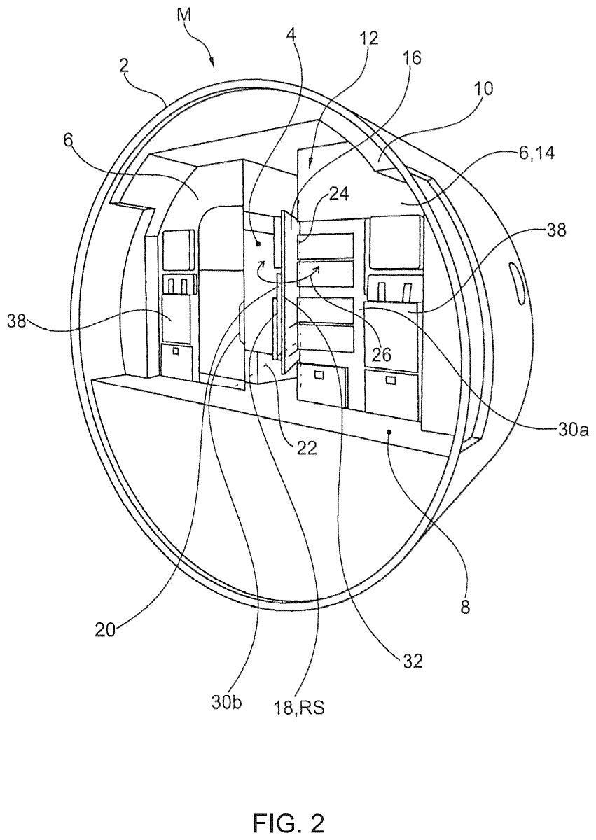

FIG. 2 shows a more detailed view of the situation from FIG. 1 in the direction of the arrow II from FIG. 1 in a perspective illustration. In this case, the seat 16 is in an intermediate position between the two end positions EP1,2. What is illustrated is thus the moment at which the seat 16 is pivoted between the two seat positions SP1,2. The seating surface 18 is in this case in the rest position RS.

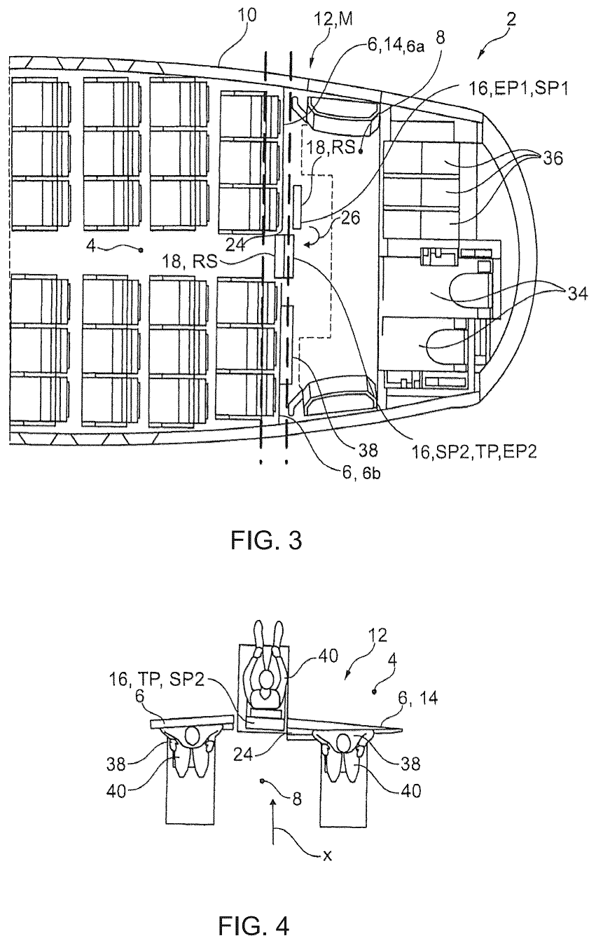

FIG. 3 shows the entire installation situation in a larger detail of the airplane 2 in the view as per FIG. 1. Additionally illustrated here are monuments such as lavatories 34 or storage compartments 36 in the service area 8, and passenger seats (not identified further) in the passenger cabin 4.

FIG. 4 symbolically shows the seat arrangement 12 once again, likewise in a plan view as per FIGS. 1 and 2. In this case, in addition to the seat 16, further fixedly installed CAS seats 38 are illustrated. Cabin crew 40, in this case flight attendants, have sat down both on the seat 16 and on the two CAS seats 38. Otherwise, the seat arrangement 12 corresponds to the one in FIGS. 1 to 3.

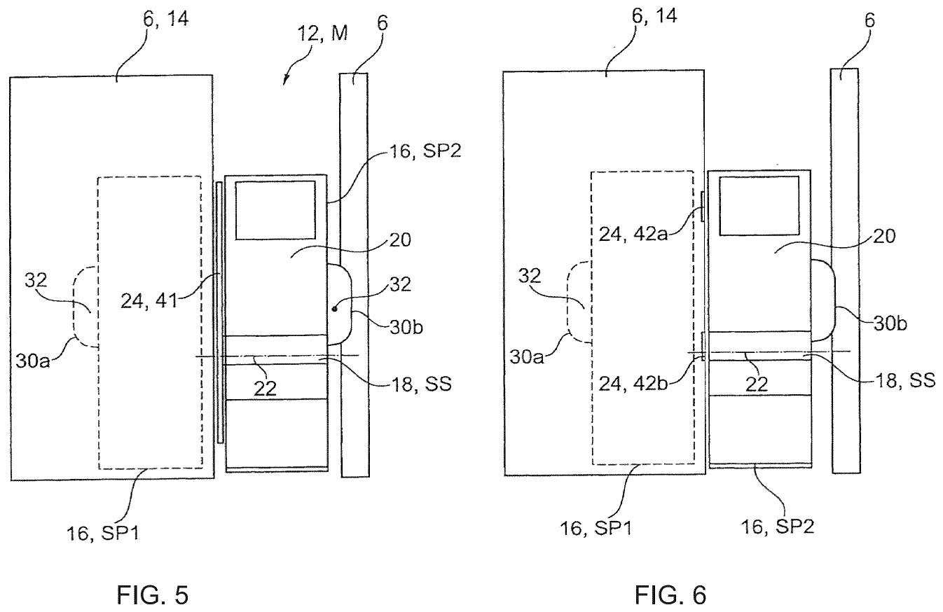

FIG. 5 shows a view of the seat arrangement 12 counter to the x direction, i.e. in the direction of the arrow V in FIG. 1. The seat 16 is in the seat position SP2. In this embodiment, the pivot pin 24 is embodied as a single continuous pivot pin in the form of a single hinge 41. Indicated by dashed lines is the seat position SP1, when the seat 16 is thus located “behind” the partition wall 6 in the picture. In the seat position SP2 of the seat 16, the seating surface 18 in the sitting position SS and the backrest 20 can be seen, and also the support element 32, which is supported on or in the support holder 30b. The pivot pin 24 is in this case embodied in a simple manner outside the partition wall 6.

FIG. 6 shows an alternative design to FIG. 5. In this case, the pivot pin 24 is embodied in two parts in the form of two part-hinges 42a,b. Furthermore, the pivot pin 24 is in this case integrated at least partially into the partition wall 6, this being more visually appealing.

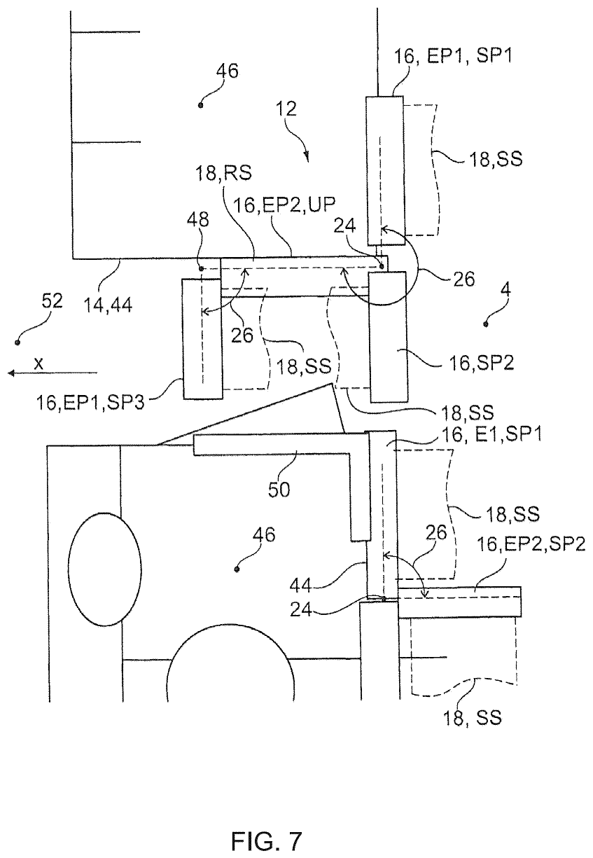

FIG. 7 shows, in a plan view as per FIG. 1 of the airplane 2, at the top, a first alternative seat arrangement 12, now in the front region of the airplane 2, namely between a cockpit 42 and the passenger cabin 4. The seat 16, only indicated here, is again fastened to the retaining wall 14 so as to be rotatable about a pivot pin 24 through an angular range 26. However, in this case, the angular range 26 extends through 270° between the two end positions EP1,2. The end position EP1 is again identical to the seat position SP1, but the end position EP2 is in this case a stowed position UP, in which the seating surface 18 is not able to be moved from the rest position RS into the sitting position SS, since it is facing the retaining wall 14. The seating surface 18 in the sitting position SS is indicated in each case by way of dashed lines and is possible in this case for the seat positions SP1 and SP2. The seat position SP2 is turned through 180° again with respect to the seat position SP1. The direction of view is in this case in the x direction, i.e. the direction of flight.

In this case, the retaining wall 14, in contrast to the previous exemplary embodiments, is not a partition but a wall portion 44 of a monument 46 for the passenger cabin, in this case a galley.

In this exemplary embodiment, the seat 16 is rotatable not only about the pivot pin 24, which in this case therefore represents a first pivot pin. Alternatively, or selectively, the seat 16 is in this case also rotatable, as required, about a second pivot pin 48. The angular range 26 between the two end positions EP1 and EP2 is in this case only 90°. This has the result that, in the end position EP1, which corresponds to a seat position SP3, a direction of view for the cabin crew is allowed which is directed counter to the direction of flight or x axis and thus toward the passenger cabin 4.

At the bottom in FIG. 7, there is a further or second seat arrangement 12: In this case, there is also a further monument 46, in this case a lavatory. A further seat 16 is also installed on the wall portion 44 thereof, said seat being mounted so as to be rotatably about the pivot pin 24 through an angular range 26 of 90° between the two end positions EP1,2, which correspond to seat positions SP1,2. As a result of the seat being pivoted away from the end position EP1, it is possible here for an enlarged access 50 to the lavatory at an angle to be allowed, this being indicated in the figure by a thickened line extending at an angle. Thus, it is possible, for example, for wheelchair users to have easier access to the lavatory.

The following is a summary list of reference numerals and the corresponding structure used in the above description of the invention:
2 Airplane
4 Passenger cabin
6 Partition wall
6a First wall portion
6b Second wall portion
7 Gap
8 Service area
10 Main structure
12 Seat arrangement
14 Retaining wall
16 Seat
18 Seating surface
20 Backrest
22 Folding axis
24 (First) pivot pin
26 Angular range
28 Lock element
29 Lock element
30a,b Support holder
32 Support element
34 Lavatory
36 Storage compartment
38 CAS seat (fixedly installed)
40 Cabin crew
41 Hinge
42a,b Part-hinge
44 Wall portion
46 Monument
48 (Second) pivot pin
50 Access
52 Cockpit
M Installed state
EP1,2 End position
SP1-3 Seat position
SS Sitting position
RS Rest position
UP Stowed position
TP TTL observation position

1. A seat configuration for a passenger cabin of an airplane, the seat configuration comprising:
a retaining wall for being permanently fastened to a main structure of the airplane when said retaining wall is in an intended installed state in the passenger cabin;
vertical pivot pins;
a seat for cabin crew members and having a seating surface being foldable between a sitting position and a rest position, said seat being fastened to said retaining wall only by means of at least one of said vertical pivot pins, said seat being rotatable about each of said vertical pivot pins between a first and a second end position, wherein the first and second end positions are offset with respect to one another through an angular range of at least 30° and at most 300°, wherein said seat is rotatable about said vertical pivot pins between at least two seat positions, wherein the sitting position of said seating surface is allowed in each of the seat positions; and
said retaining wall is a partition wall for the passenger cabin, and said partition wall has a first wall portion and a second wall portion, wherein said first and second wall portions are separated by a gap and said seat is rotatable into one of the first and second end positions in which said seat is disposed in said gap.

2. The seat configuration according to claim 1, wherein with regard to at least one of said pivot pins, at least one of the seat positions is one of the first and second end positions.

3. The seat configuration according to claim 2, wherein with regard to at least one of said pivot pins, two of the seat positions are the first and second end positions.

4. The seat configuration according to claim 1, wherein with regard to at least one of said pivot pins, said seat is rotatable into at least one stowed position, in which the sitting position of said seating surface is not allowed.

5. The seat configuration according to claim 4, wherein with regard to at least one of said pivot pins, the at least one stowed position is one of the first and second end positions.

6. The seat configuration according to claim 1, wherein with regard to at least one of said pivot pins, the sitting position of said seating surface is allowed in each rotational position of said seat between the first and second end positions.

7. The seat configuration according to claim 1, wherein said seat is located parallel to and in front of said retaining wall in at least one of the seat positions.

8. The seat configuration according to claim 1, wherein said retaining wall is a wall portion of a monument for the passenger cabin.

9. The seat configuration according to claim 1, further comprising at least one lock element configured to lock said seat in at least one of the first and second end positions and/or the seat positions and/or stowed positions.

10. The seat configuration according to claim 9, further comprising a first lock element, configured to lock said seat in the first end position and/or one of the seat positions, and a second lock element, configured to lock said seat in the second end position and/or another of the seat positions.

11. The seat configuration according to claim 1,
further comprising at least one support holder fastened to said retaining wall; and
wherein said seat has a support element with which it is able to be supported on said at least one support holder in at least one of the first and second end positions and/or the seat positions and/or stowed positions.

12. An airplane, comprising:
a main structure;
a passenger cabin; and
said seat configuration according to claim 1 disposed in said passenger cabin in the intended installed state, wherein said retaining wall is permanently fastened to said main structure of the airplane, wherein said seat is rotatable about each of said pivot pins between the first and second end positions, wherein said seat is rotatable about said pivot pins between the seat positions, wherein the sitting position of said seating surface is allowed in each of the seat positions.

13. The airplane according to claim 12, wherein said seat is fastened to said main structure only indirectly via said retaining wall.

14. The airplane according to claim 12, wherein one of the seat positions is a taxiing, takeoff and landing observation position for said passenger cabin.

15. The airplane according to claim 12, further comprising at least one lock element which is configured to lock said seat in at least one of the first and second end positions and/or the seat positions and/or stowed positions.

16. The airplane according to claim 12,
further comprising at least one support holder fastened to said main structure; and
wherein said seat has a support element with which it is supported on said at least one support holder in at least one of the first and second end positions and/or the seat positions and/or stowed positions.

17. The airplane according to claim 16, wherein said retaining wall contains or forms said at least one support holder.
